(19) United States
(12) Patent Application Publication
(10) Pub. No.: US 2013/0331058 A1
(43) Pub. Date: Dec. 12, 2013

(54) EMERGENCY ALERT SYSTEM

(71) Applicant: HELP NOW TECHNOLOGIES, LLC, Grand Rapids, MI (US)

(72) Inventor: Rebecca S. Harvey, Grand Rapids, MI (US)

(73) Assignee: HELP NOW TECHNOLOGIES, LLC, Grand Rapids, MI (US)

(21) Appl. No.: 13/788,030

(22) Filed: Mar. 7, 2013

Related U.S. Application Data
(60) Provisional application No. 61/658,526, filed on Jun. 12, 2012.

(51) Int. Cl. H04W 4/22

(52) U.S. Cl. CPC H04W 4/22
USPC 455/404.2

(57) ABSTRACT

An emergency alert device is adapted to be worn by a user and to automatically make a cellular phone call to an emergency services center upon activation by a user. The device automatically transmits its current location—derived from GPS, cellular telephone triangulation, or otherwise—via text message, if the emergency services center is equipped to receive text messages, or via a synthesized voice if the emergency services center is not so equipped. The user does not need to dial any phone numbers to activate the call. The device may be attached to, or incorporated into, a wrist watch. A text message is also automatically sent to a recipient who is pre-designated by the user. The text message includes the current location of the user. Repeated text messages are sent if the user's position changes by more than a threshold.

### CROSS-REFERENCE TO RELATED APPLICATIONS

This application claims priority to U.S. patent application Ser. No. 61/658,526 filed Jun. 12, 2012 by applicant Rebecca S. Harvey, entitled EMERGENCY ALERT SYSTEM, the complete disclosure of which is hereby incorporated herein by reference.

### BACKGROUND OF THE INVENTION

The present invention relates to emergency alerting systems and/or devices that may be used to contact emergency services operators and/or other people in the case of an emergency.

In the event of a medical emergency, a security emergency, or any other type of emergency in which assistance is required, a person may wish to summon assistance by calling 911, or by dialing other digits that place the person needing help in communication with an emergency service operator. In some situations, however, the person needing assistance may not be able to make a conventional phone call. For example, the person may be suffering from a health emergency that makes it difficult to dial phone numbers on a cell phone, or other phone. In other situations, the person needing help may be physically prevented from making a phone call by an attacker.

Some existing emergency help systems enable a person to summon help with the push of a button, or other simple act, but suffer from other disadvantages. For example, in some emergency help systems, a user wears a device that, when activated, makes contact with an intermediate call center. Only after the intermediate call center has gathered the appropriate information from the user, or otherwise performed its own investigation, will contact be made with the public first responders. This can delay the process of summoning help.

In other situations, existing emergency help systems are wirelessly tethered to a base unit that is often connected to a hard-wired telephone line. That is, the user must be within wireless range of the base unit for the system to work. The base unit typically sits somewhere in the user's residence and does not have a range that extends outside the person's residence. Still further, in some existing emergency help systems, a user is unable to silently and quickly contact an emergency services operator without making the verbal sounds and/or taking the time necessary for conventional phone calls.

### SUMMARY OF THE INVENTION

The various aspects of the present invention provide a system, device, and/or method that allows simple, fast, and automatic communication with an emergency services operator. The device may be worn by a user and, upon activation, all desired emergency communications are subsequently made without further user intervention. This ensures that communication with the emergency services operator will take place even if the person activating the device later becomes incapacitated due to a medical issue, a security issue, or still other issues. The communication will also automatically include a location of the person requesting help so that the emergency services operator will be apprised of the person's current location. Still further, the communication takes place directly with the first responders (e.g the Public Safety Answering Point), and is not routed through any intermediary call centers that delay communication with the first responders.

According to one embodiment, an emergency alert device is provided that includes a wearable alert device, a user control coupled to the alert device, and a controller having a cellular transceiver. The user control is adapted to activate the device when prompted by the user, which causes the controller to automatically communicate a current location of the wearable alert device to an emergency services operator using the cellular transceiver. The controller also automatically sends a text message to a predetermined recipient upon a user activating the user control. The predetermined recipient is different from the emergency services operator.

According to another embodiment, a method of alerting an emergency services operator is provided that includes providing a wearable alert device; activating the alert device during an emergency; automatically transmitting a current location of the wearable device to an emergency services operator; and automatically transmitting a text message from the wearable alert device to a predetermined recipient different from the emergency services operator.

In other embodiments, the alert device may lack any controls for enabling a user to dial an arbitrary phone number. The controller of the device may automatically communicate with the emergency services operator by either dialing 911 or by sending a text message to an e911 emergency services operator. The device may be configurable by a user to allow the user to pre-select which types of these two communications will be undertaken when the device is activated. If the communication is made by dialing 911, a predetermined aural message may be communicated by the controller after the emergency services operator answers the call.

In other embodiments, the controller may periodically re-determine the location of the wearable device after automatically communicating with the emergency services operator and forward any new location information to the emergency services operator. The location of the wearable device may be determined based upon communications with at least one cell phone tower, or upon signals from satellites of a global positioning system (GPS).

The device may be adapted to be worn on a person's wrist. In some embodiments, the device may include a wrist band that may be wrapped around a user's wrist. In other embodiments, the device may include a fastener adapted to attach to the wrist band of a watch worn by a user. When adapted to attach to the wrist band of a watch worn by the user, the device may include a disk shaped housing inside of which is positioned the controller, wherein the disk shaped housing is sized and positioned to lie underneath the wrist watch worn by the user. In still other embodiments, the wearable alert device may include a watch integrated therein for displaying time to the user of the wearable device.

The user control of the wearable device may include a plurality of switches that must be simultaneously activated for a predetermined time period in order to cause the controller to initiate the emergency communication with the emergency services operator. The user control may further be adapted to be activatable only by human touch so as to exclude, or reduce, the possibility of inadvertent activation.

The wearable device may further be configurable by a user so as to allow the user to select, prior to the activation of the device, the predetermined recipient of the text message. The device may further be configurable by a user so as to allow the user to select the content of the text message.

In still other embodiments, the wearable device may be configured so as to not allow the device to terminate an emergency phone call made to 911 until the emergency services operator terminates the phone call. In this manner, an intruder, attacker, or other non-authorized individual cannot stop the emergency communication once the device has been activated.

The wearable device may include a mini or micro universal serial bus (USB) port adapted to allow a user to configure the wearable device and to re-charge a battery contained within the wearable device.

In still other embodiments, the wearable device may further include a satellite transceiver adapted to communicate with an emergency services operator via satellite. Such satellite communication may include the transmission of the current location of the wearable device, and such communication may take place if the controller is unable to successfully communicate with the emergency services operator via the cellular transceiver.

In still other embodiments, the device may also automatically transmit a second text message to a second predetermined recipient upon a user activating the user control wherein the second predetermined recipient is different from the first predetermined recipient.

An aural indicator may also be provided in some embodiments that emits an aural sound when the device is activated by a user in order to draw attention to the person needing assistance, and/or to ward off potential attackers.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and is capable of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a perspective view of a wearable alert device according to a first embodiment;

FIG. 2 is a plan view of the alert device of FIG. 1;

FIG. 3 is a first elevational view of the device of FIG. 1;

FIG. 4 is a second elevational view of the device of FIG. 1 taken from a direction orthogonal to the direction of FIG. 3;

FIG. 5 is a perspective, exploded view of the device of FIG. 1 (and the device of FIGS. 6-10) showing the internal components;

FIG. 6 is a perspective view of a wearable alert device according to a second embodiment;

FIG. 7 is a plan view of the alert device of FIG. 6;

FIG. 8 is a first elevational view of the device of FIG. 6;

FIG. 9 is a second elevational view of the device of FIG. 6 taken from a direction orthogonal to the direction of FIG. 6;

FIG. 10 is a sectional view of the alert device of FIG. 6 taken along the line X-X in FIG. 7;

FIG. 11 is a perspective view of a wearable alert device according to a third embodiment;

FIG. 12 is a perspective view of the alert device of FIG. 11 shown with a pair of sliding doors moved to an open position;

FIG. 13 is a perspective, exploded view of the device of FIG. 11;

FIG. 14 is a plan view of the device of FIG. 11 shown attached to a conventional wrist watch;

FIG. 15 is a partial front view of a wearable alert device according to a fourth embodiment in which the alert device and a watch are integrated together;

FIG. 16 is a side view of the device of FIG. 15;

FIG. 17 is a front view of the device of FIG. 15 shown with a pair of sliding doors moved to an open position;

FIG. 18 is a front view of the device of FIG. 15 shown attached to a wrist of a user;

FIG. 19 is a flow chart of an illustrative algorithm that may be followed by a controller of any of the wearable alert devices described herein;

FIG. 20 is a perspective view of an alert device according to a fifth embodiment;

FIG. 21 is a perspective, exploded view of the alert device of FIG. 20;

FIG. 22 is a perspective, exploded view of an alert device according to a sixth embodiment; and

FIG. 23 is a plan view of the alert device of FIG. 22.

### DETAILED DESCRIPTION OF THE EMBODIMENTS

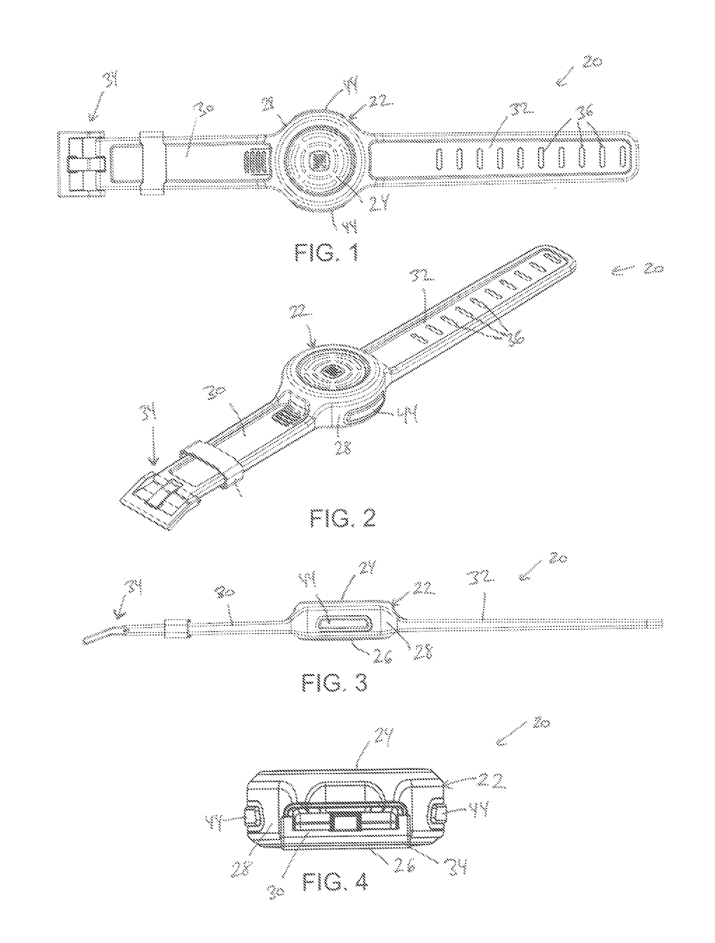

A wearable emergency alert device 20 according to a first embodiment is shown in FIG. 1. Alert device 20 includes a generally cylindrical or disk shaped housing 22 having a top face 24, a bottom face 26, and a perimeter wall 28. A first band 30 is coupled to, or integrated into, housing 22 along a first side, while a second band 32 is coupled to, or integrated into, housing 22 along a second side that is opposite to the first side. First and second bands 30 and 32 are adapted to allow wearable alert device 20 to be releasably attached to a person's wrist. To that end, first band 30 may include a buckle 34 attached at an end opposite housing 22, while second band 32 may include a series of holes or apertures 36 to which the prong of buckle 34 may be selectively inserted in order to secure device 20 to wrists of varying diameter. It will be understood that the combination of buckle 34 and apertures 36 could be replaced by other fastening systems for enabling device 20 to be worn on a user's wrist, such as, but not limited to, hook-and-loop type fasteners (e.g. Velcro), as well as other fasteners. It will also be understood that device 20 could include structures other than bands 30 and 32 that are adapted to facilitate a user wearing device 20 on locations other than a person's wrist, such as, but not limited to, structures adapted to attach device 20 to a necklace, to a belt loop, to a cell phone, to a shoe, or to still other things.

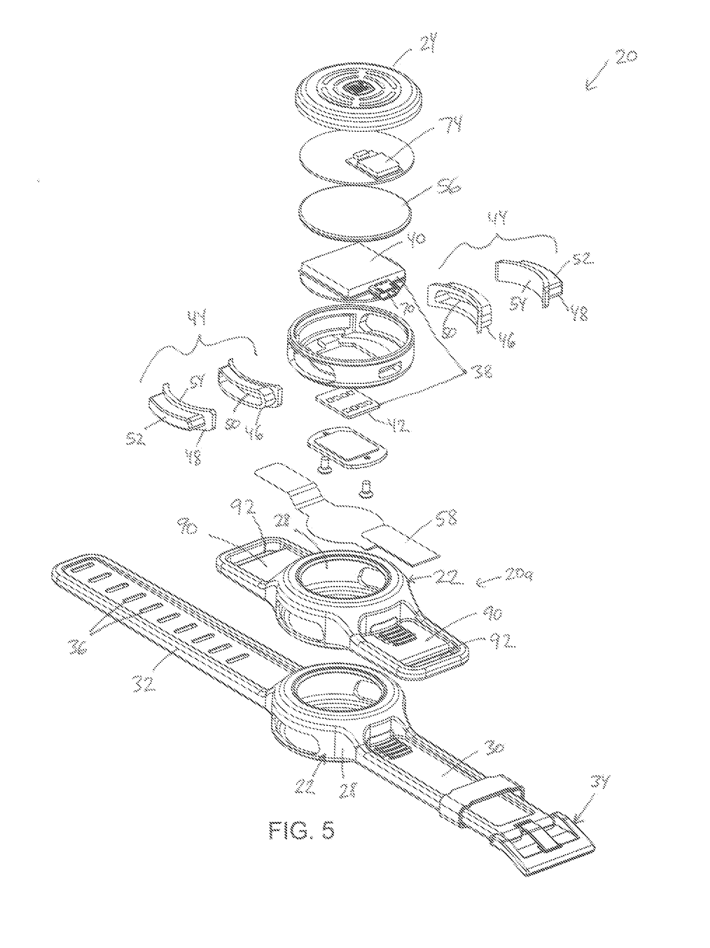

A controller 38 is positioned inside of housing 22 (FIG. 5). Controller 38 includes one or more electrical components that are capable of carrying out the functions described herein, as would be known to one of ordinary skill in the art. The precise number of components, as well as their arrangement and the selection of the specific components, may vary from embodiment to embodiment. In the embodiment illustrated in FIG. 5, controller 38 includes an electronic control module 40 and a micro Subscriber Identity Module (SIM) card 42. In at least one embodiment, the electronic control module 40 is a module that combines the ability for both Global System for Mobile Communication (GSM) communications and General Packet Radio Service (GPRS) communications. One such commercially available module is marketed by Telit Wireless Solutions, which has a place of business in Morrisville, N.C., USA, under the part number GE865-Quad. Another commercially available module is also marketed by Telit Wireless Solutions under the part number GE864-GPS. Still other commercially available modules include part number BGS2 marketed by Cinterion of Munich, Germany, as well as the LEON G-100 and/or LEON G200 GSM/GPRS modules marketed by u-blox of Thalwil, Switzerland. It will be understood by those skilled in the art that other types of control modules 40 may be used.

It will also be understood by those skilled in the art that controller 38 and control module 40 can be varied to include any combination of microcontrollers, microprocessors, modules, systems-on-a chip, field programmable gate arrays (FPGAs), discrete circuitry, software, hardware, and/or firmware that is capable of carrying out the control algorithms described herein, as would be known to a person skilled in the art. In some embodiments, a microcontroller, or other electronic structure, is used in combination with control module 40 and SIM card 42. This may be beneficial in some instances where control module 40 does not support scripting or otherwise does not provide the desired level of software functionality.

Controller 38 is configured and/or programmed to provide emergency notification to one or more individuals in case of an emergency. Such an emergency could be a medical emergency, in which case an ambulance or other emergency medical personnel are needed, either for the wearer of device 20 (or 20a, 20b, 20c, 20d, and/or 20e—as these embodiments are described in greater detail below), or someone nearby to the wearer of device 20, or it could be a security emergency, in which case police, or other security personnel, are needed; or it could be for other types of emergencies. When activated by a user, controller 38 is configured to directly contact an emergency services operator (such as via 911, or via an e911 service) as well as to send a text message to a designated recipient during an emergency. This contact is made directly to the emergency services operator (e.g. 911 operator) and does not require an intermediate call made to a call center, which then forwards the call onto the emergency services operator.

This contacting of the emergency services operator and the sending of a text message are done automatically upon the activation of device 20 so that the wearer does not need to perform any further action after activating device 20. By automating this process, the emergency communications are made faster. Further, by automating this process, the possibility that the wearer might become incapacitated—either medically or by an attacker—does not prevent the emergency communications from occurring. In other words, if the user of device 20 were required to take further steps after activating the device, it is possible that the wearer might not be able to complete those additional steps prior to becoming incapacitated, and thus not be able to make the desired emergency contacts. By automating the process after activation, however, such additional steps are eliminated, and the likelihood of incapacitation occurring prior to emergency notification occurring is reduced.

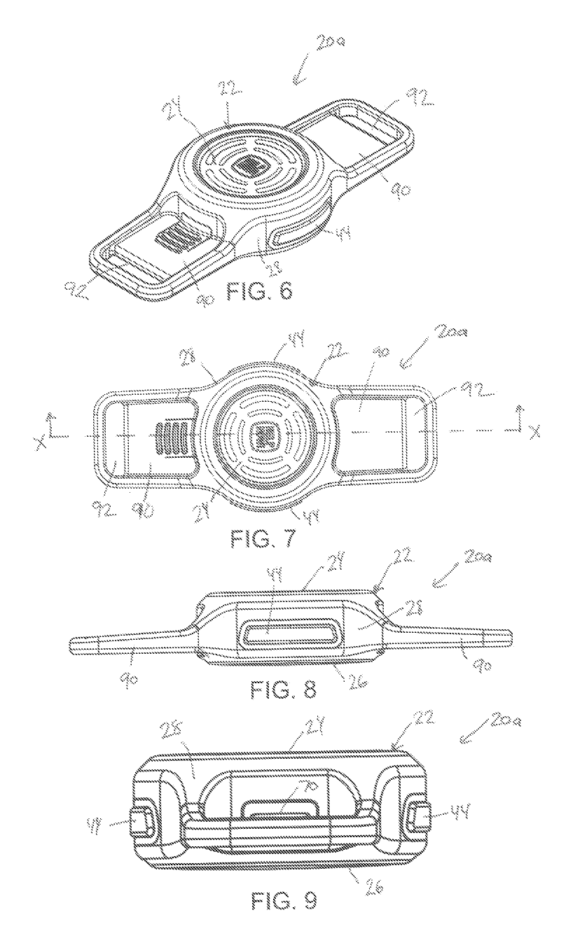

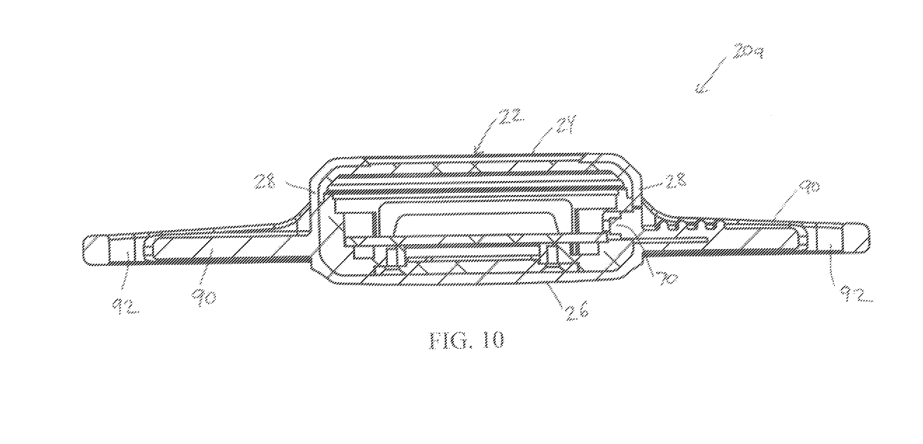

In the embodiments illustrated in FIGS. 1-10, devices 20 and 20a are activated by a user simultaneously pressing a pair of tactile switches or buttons 44 that are positioned on opposite sides of housing 22. Tactile switches 44 may be any conventional tactile switch that responds to human touch. In one embodiment, tactile switches 44 are switches that are responsive to both force and the temperature of a user's fingers. That is, the simultaneous squeezing of both tactile buttons 44 by one or more objects that are cooler than a user's fingers will not activate device 20. Further, the contact of tactile switches 44 by a person's fingers, or other heated objects, will also not cause the activation of device 20 in the absence of sufficient pressure also being applied to switches 44. By requiring both sufficient force and temperature to be applied to switches 44, the likelihood of inadvertent activation of device 20 or 20a is reduced.

In other embodiments, tactile switches 44 are used that are not temperature sensitive. For example, in the embodiment shown in FIGS. 1-10, capacitive sensors (not shown) are used to detect the pressing of tactile switches 44. Such capacitive sensors are configured to operate in response to the electrical characteristics of the human fingers so that pressing of the switches 44 by inanimate objects does not activate device 20 or 20a. Such capacitive type sensors may be similar to capacitive touch screen technology used in some cell phones, or it may be based on other capacitive sensing technology. Still other types of sensor and/or switches may be used.

In the embodiment of FIGS. 1-10, each tactile switch 44 includes a stationary switch body 46 and a movable switch component 48. Stationary switch body 46 includes a central aperture 50 through which an extension 52 on movable switch component 48 is inserted. When a user desires to activate device 20 or 20a, the user pushes on extension 52 of both movable switch components 48, which in turn causes movable switch component 48 to move radially inward toward the center of housing 22. Stationary switch body 46 remains stationary during this movement of switch component 48. A rear wall 54 of movable switch component 48 also moves radially inward toward the center of housing 22 when extensions 52 are pressed. The inward movement of extension 52 and/or rear wall 54 is detected by a switch sensor (not shown) positioned adjacent rear wall 54. When the switch sensor detects the pressing of tactile switches 44, it forwards a signal to controller 38 indicating such detection.

In some embodiments, device 20 (or 20a, 20b, 20c, 20d, and/or 20e) is configured so that activation does not occur until after switches 44 have been pressed for a predetermined amount of time. This time threshold requirement may be included with any of the physical switch and sensor embodiments discussed above. The length of this threshold time period may vary from embodiment to embodiment, but generally would be in the vicinity of one to two seconds, although other time periods may be used. By requiring switches 44 to be pressed (either with or without the temperature requirements discussed above, depending upon the switch/sensor embodiment) for a certain minimum time period, any inadvertent transient forces that might otherwise squeeze together switches 44 do not cause activation of device 20. This also helps reduce the likelihood of inadvertent activation of device 20, which in turn reduces the likelihood of inadvertent calls or communications with emergency service operators. The monitoring of the length of time that switches 44 are pressed is carried out by controller 38, although it alternatively could be carried out by one or more separate electrical structures that send a signal to controller 38 when the time threshold has been reached. In some embodiments, therefore, controller 38 may be initially turned on when switches 44 are pressed, at which point it begins monitoring the length of time switches 44 are continuously pressed, and then either stays on (if sufficient time has passed), or shuts off (if sufficient time does not pass). In other embodiments, one or more mechanical structures can be used to ensure that a threshold amount of time passes while switches 44 are pressed before controller 38 and/or device 20 is activated.

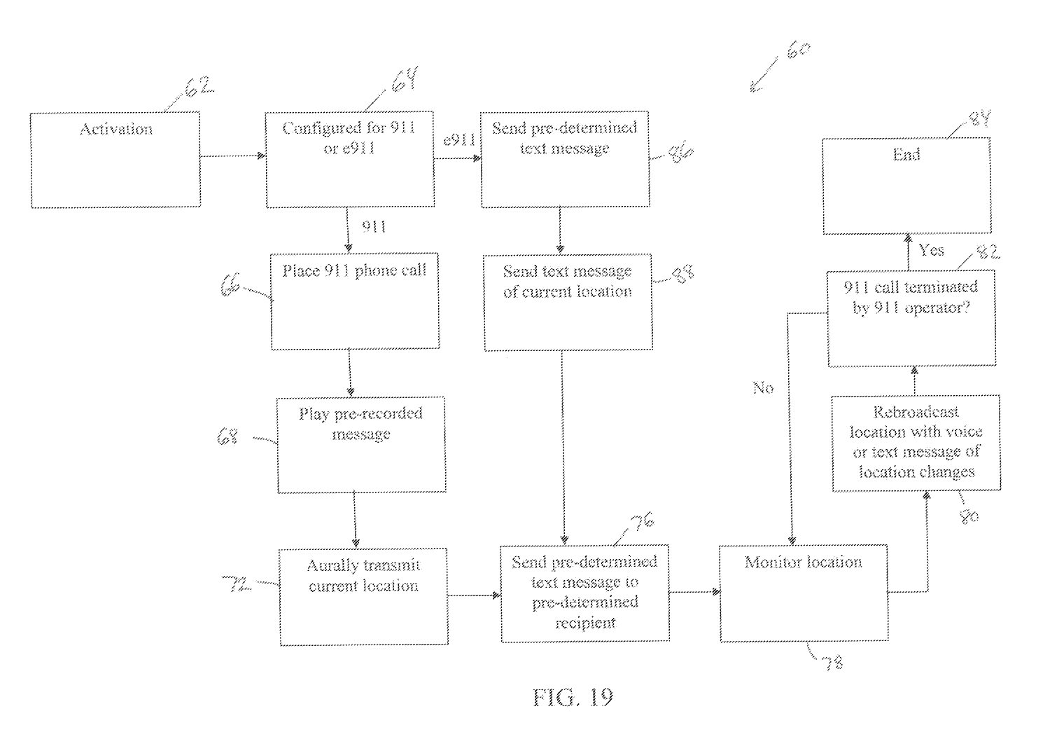

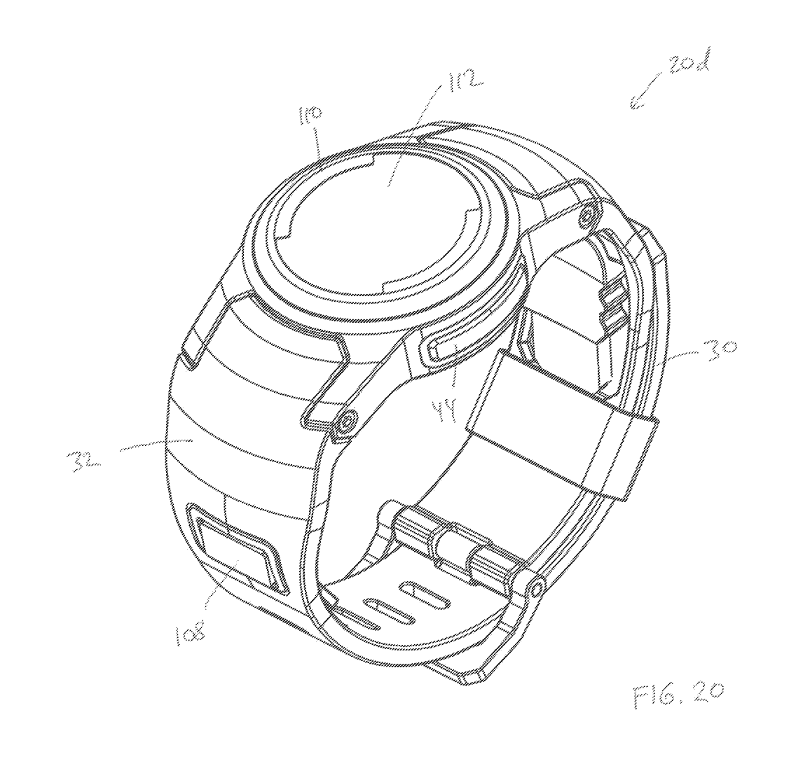

Once device 20 (or 20a, 20b, 20c, 20d, or 20e) has been activated—regardless of the specific manner—controller 38 is configured to carry out an alerting algorithm that transmits an emergency notification to one or more emergency service operators. FIG. 19 illustrates one example of a notification algorithm 60 that may be followed by controller 38. It will be understood that modifications may be made to algorithm 60, and that other algorithms may be used. It will also be understood that the description of algorithm 60 below is carried out with respect to device 20 for purposes of illustration, and that algorithm 60 may be incorporated into any of the devices described herein (e.g. devices 20a, 20b, 20c, 20d, and/or 20e)

Algorithm 60 begins at an activation step 62. Activation step 62 refers to the simultaneous pressing of tactile switches 44 in any of the manners described above (e.g. with or without temperature sensing, with or without a threshold time period, etc.) Activation step 62 results in the activation of controller 38, which then carries out and/or oversees the remaining steps in algorithm 60. After activation step 62, control proceeds to a subsequent step 64 in which controller 38 determines whether it has been configured for use with a conventional 911 emergency call system, or a newer enhanced 911, or e911, emergency call system. In one embodiment, the default setting of wearable alert device 20 is a conventional 911 phone system with the user having the option of changing this configuration, such as by connecting device 20 to a computer, or other electronic device, using cables (such as, but not limited to, a Universal Serial Bus (USB)) or via wireless means (e.g. Bluetooth, Zigbee, WIFI, etc.). In other embodiments, the default option is toward the e911 system.

Before proceeding further to describe the subsequent steps of algorithm 60, it should be understood that the reference to an e911 system is intended to include any and all current versions of e911 systems that have been implemented by telecommunications companies and emergency service call centers, as well as any and all future versions of such e911 systems. Without limitation, such future e911 systems include emergency systems in which text, photos, and/or video able to be forwarded to a 911 call center. Such future e911 systems also include systems in which the 911 backend service is switched from a circuit-switched system to an IP-based architecture.

Still further, it will be understood by those skilled in the art that the references herein to a 911 or e911 system are made for illustrative purposes only. Wearable device 20 may be adapted to operate in the same manner described herein in jurisdictions where emergency services are contacted via different telephone numbers. Thus, for example, wearable device 20 could be modified to automatically dial 000 in Australia, 100 in Israel, 108 in India, 111 in New Zealand, 112 in the European Union, 117 in the Philippines, and 999 in Poland, Ireland, and various other non EU countries, as well as still other numbers for different countries and/or jurisdictions. Changing the number which is automatically dialed can be carried out by connecting a portable computer, smart phone, or other suitably programmed device to wearable device 20 via the USB port. In some embodiments, wearable device 20 is further modified so that it automatically determines what jurisdiction it is currently located in and chooses the appropriate emergency number to use for placing an emergency call. Such automatic jurisdiction determination is carried out by, for example, having controller 38 communicate with the available cell phone towers and either receive location/jurisdiction information from them, or by triangulating a geographic location from multiple cell phone towers, which controller 38 then uses to consult a database stored in memory of device 20 that maps geographic locations to emergency phone numbers. Regardless of whether or not such automatic jurisdiction determination is included or not, references herein to 911 and e911 herein will be understood to include the emergency phone numbers in use in other countries and/or jurisdictions.

If controller 38 determines at step 64 that device 20 is currently configured for a conventional 911 call, it proceeds to step 66 where it places a conventional 911 phone call. This phone call is made using SIM card 42 and control module 40, but does not involve the user having to press any buttons, dial any numbers, or do any other physical steps other than whatever is required for activation step 62. Controller 38 is further programmed to monitor the communication line between device 20 and the emergency call center (sometimes referred to as the Public Safety Answering Point). When controller 38 detects that an emergency services operator has answered the 911 call, controller 38 moves to step 68 where it plays a pre-recorded voice message that is transmitted by device 20 to the emergency services operator. In other words, controller 38 wirelessly transmits a pre-recorded voice message to the emergency services operator (via the telecommunications cellular network) that the emergency services operator hears.

The pre-recorded voice message will typically consist of a verbal request for help. While virtually any specific message may be used, the verbal request may desirably be short, clear, and easily understood, such as, but not limited to, “Help. Please send emergency services now.” In some embodiments, the message may be automatically repeated several times. Regardless of whether it is repeated or not, the pre-recorded message may be stored digitally in a memory that is accessible to controller 38. The format of the pre-recorded voice may be any suitable format, including, but not limited to, one or more MP3 files. In some embodiments, such memory may be contained within control module 40, or it may be located elsewhere. Regardless of its location, controller 38 accesses the pre-recorded message upon establishing a successful connection with the emergency services operator.

In some embodiments, wearable device 20 does not include any speakers, or other circuitry, that would allow any voice communications from the emergency services operator to be heard by the user of device 20. In other embodiments, wearable device 20 is modified to include one or more speakers, or other devices, that enable the voice of the emergency services operator to be heard. In still other embodiments, wearable device 20 includes one or more microphones thereon that enable the user to speak with the emergency services operator via device 20. In still other embodiments, wearable device 20 includes a video camera integrated therein that is in communication with controller 38. Controller 38 is programmed to store the video in a memory on device 20, and/or to transmit it to the emergency services center, depending upon the type of connection established with the emergency services center. In the embodiments shown in FIGS. 1-10, no speaker, video camera, or microphone are included.

Wearable device 20 is configured to allow the pre-recorded voice message of step 68 to be created by a user of device 20. That is, in the embodiments of FIGS. 1-10, wearable devices 20 and 20a include a connector or port 70 into which a cable, cord, or other device, may be inserted. More specifically, in the embodiments of FIGS. 1-10, wearable devices 20 and 20a include a micro-USB port 70 into which a conventional micro-USB cable may be plugged. The other end of the cable is then plugged into a conventional personal computer, cell phone, or other external device that is programmed in a manner to communicate with device 20, 20a. If the external device is a computer, or other device that includes a microphone and sound-recording abilities, the user of device 20, 20a pre-records the voice message used in step 68 by speaking into a microphone coupled to the computer or other device and saving the electronic voice file on the computer or other device. The user may then transfer the electronic voice file to wearable device 20, 20a via the micro-USB cable. In this manner, the user of device 20, 20a can create a pre-recorded voice message in his or her own voice. Device 20, 20a may be configured such that it is compatible with any one or more of Windows XP®, Windows 7, Windows 8, OS 10.4, Linux, or newer operating systems, as well as still other operating systems.

In some embodiments, the voice message of step 68 is pre-stored within device 20, 20a so that a user does not need to transfer any audio files to device 20, 20a prior to use. In such embodiments, a user is given the option of over-riding these pre-recorded messages by transferring their own voice recordings to the alert device via the micro USB cable, or other type of cable. Indeed, as was noted, in some embodiments, device 20, 20a may include a short range wireless communications ability that allows it to be configured by the user without the need for a wired connection (e.g. Zigbee, Bluetooth, infrared, etc.)

In the embodiment of notification algorithm 60 shown in FIG. 19, controller 38 proceeds to step 72 after the pre-recorded message of step 68 has been played (one or more times). At step 72, which may be omitted in some embodiments, controller 38 transmits the current location of device 20 to the emergency services operator. In some embodiments, this location is derived from a GPS unit 74 (FIG. 5) that is included within device 20. In other embodiments, this location is derived from any conventional radiolocation method (e.g. triangulation, trilateration or multilateration, etc.) using the one or more towers of the cellular telephone network with which device 20 is currently communicating. If transmitting the location based upon a radiolocation technique, the precise location of the device 20 may not be determinable, so that a range of possible locations may be transmitted by device 20. If transmitting the location using GPS, the location of device 20 may be pinpointed with greater accuracy, so that it may be possible to transmit a precise location, rather than a range, to the emergency services operator via device 20.

Regardless of whether a specific location, or a range of possible locations is broadcast, device 20 automatically converts the location information into an aural message for transmission via the cellular communications connection to the emergency services operator. This conversion is carried out by any suitable speech synthesizing software, hardware, and/or firmware. The conversion may be from a SMS format output by the GPS unit 74, or it may be from any other format that is output by the GPS unit 74.

In some jurisdictions and/or situations, the telecommunications company that operates or oversees the cellular telephony network on which an emergency cell phone call is made may automatically forward an approximate location of the emergency cell phone call to the emergency services operator. In such jurisdictions and/or situations, this automatic forwarding of the location of the cell phone making the emergency phone call may be in addition to the location forwarding performed in step 72. That is, from the standpoint of the telecommunications carrier (e.g. Verizon Wireless, AT&T, Sprint, etc.), device 20 is treated as just another cell phone. When device 20 calls the emergency services operator, the telecommunications company therefore may automatically forward location information to the emergency services operator that is independent of the information forwarded aurally by device 20.

Depending upon the telecommunications carrier, the user of device 20 may have to register device 20 with a selected telecommunications carrier (e.g. Verizon Wireless, AT&T, Sprint, etc.) and pay a monthly or yearly service fee in order to enable device 20 to operate properly. In some situations, this fee may be reduced from the standard monthly fees charged for cell phone users because of the limited nature of the communications that are possible with device 20. In still other situations, it may be possible for a user who already has cell phone service with a particular telecommunications company to add coverage for device 20 for little or no extra fee. Indeed, government regulation may some day require the telecommunication companies to process emergency wireless phone calls, such as those made by device 20, without charging any fee. Regardless of the fees, or lack of fees, device 20 is configured to carry out step 66 using the same communication principles as are used for conventional cell phones.

Because some telecommunications carriers may already transmit the location of device 20 to the emergency services operator, step 72 could be omitted in some embodiments. Further, in some embodiments, the transmission of current location at step 72 may not occur immediately after step 68. For example, if the current location is being determined based upon information from GPS unit 74, it may take some moments before a GPS-determined location is available for transmission. This may be especially true in those embodiments where device 20 remains completely off prior to activation step 62 (i.e. controller 38 is not communicating with any cellular towers, nor processing any GPS signals, prior to activation step 62). In other embodiments, device 20 may be making periodic location determinations prior to activation step 62 so that, upon activation, its location may more quickly be determined and forwarded to the emergency services operator.

After controller 38 completes step 72, controller 38 proceeds to a secondary notification step 76. Secondary notification step 76 involves transmitting a predetermined text message from device 20 to a predetermined recipient. As with all of the steps of notification algorithm 60, step 76 is carried out automatically by controller 38 without requiring any further input from the user of device 20 (beyond the requirements of activation step 62). The text message may be a Short Message Service (SMS) text, or it may be any other type of text message.

Both the predetermined recipient and the predetermined message that is transmitted at step 76 are configurable by the user of device 20. Such configuration takes place in a manner similar to the way in which the pre-recorded message of step 68 is configured. That is, an external computing device is coupled to device 20 via port 70, or wirelessly, and the telephone number of the desired recipient of the text message, as well as the content of the text message, is communicated to device 20 for storage in a memory contained within device 20. While the user of device 20 has the option of selecting the recipient and content of this secondary notification, it would normally be expected that the user would select a close friend, relative, family member, or other individual who they would desirably like to notify in case of an emergency.

After controller 38 sends the text message at step 76, which could include the transmission of multiple text messages to multiple recipients, controller 38 periodically re-checks the location of device 20 at step 78. If the location of device 20 changes by more than a predetermined amount, controller 38 proceeds to step 80 where it rebroadcasts its location, first to the emergency services operator and second (optionally) to the recipient of the text message of step 76. In this manner, the emergency services operator will be apprised of any change in location of the wearer of device 20, as well as the recipient of the text message. In one embodiment, the predetermined amount is 5 meters, although it will be understood that numbers greater or smaller than this can be used to trigger a location rebroadcast.

After step 80, controller 38 determines at step 82 whether the emergency service operator (e.g. 911 phone operator) has hung up or is still on the line. If the operator has not hung up, controller 38 returns to step 78 where it continues to monitor its location and provide location updates at step 80. If the operator has hung up, then controller 38 proceeds to end step 84 where algorithm 60 comes to an end. It should be noted that, in the embodiment of notification algorithm 60 illustrated in FIG. 19, only the emergency services operator can terminate the call placed by device 20. The user of device 20 does not have the ability to terminate the call, or to stop the call from being made once activation step 62 has been completed. In this manner, if the emergency involves an attacker, the attacker is prevented from stopping the notification to emergency services being made once device 20 has been activated.

Returning to step 64 of notification algorithm 60, if controller 38 determines at step 64 that it has been configured to communicate with an e911 system at step 64, it will proceed to step 86. At step 86, controller 38 will send a text message to the e911 system that indicates that the user of device 20 wants to report an emergency situation. As with the prerecorded message of step 68, the text message of step 86 is predetermined and configurable by the user of device 20 (such as via micro-USB connector 70, or by other means). The text message may be a Short Message Service (SMS) text message, or it may be another type of text message. In some cases, controller 38 will then proceed to step 88 where it will send a second text message to the e911 service that includes the current location, or current location range, of wearable device 20. In other embodiments, controller 38 will combine steps 86 and 88 into a single text message that includes content indicating both an emergency situation and the current location of device 20. Regardless of whether one or two text messages are sent by device 20, control proceeds to step 76 after the current location of device 20 has been transmitted to the e911 system. Once control has passed to step 76, controller 38 follows step 76 and the subsequent steps in the manner that has been described above.

As was noted above, algorithm 60 may be modified in a variety of different manners. As but one example, one or more notifications, whether visible and/or aural, may be provided by device 20 at one or more times during the performance of algorithm 60. For example, a visible light, such as an LED, may be illuminated after device 20 has been successfully activated, and/or after phone contact has been successfully made with the emergency services operator. In some embodiments, multiple lights could be included that provide indications of other tasks or steps being completed.

Sound may also be added in some embodiments. For example, in one embodiment, beeping and/or other types of sound are emitted from device 20 upon successful activation. However, in some situations, it may be desirable to avoid sound being emitted—such as where the wearer is hiding from an attacker, or potential attacker—so device 20 may, in some embodiments, allow the sound to be muted, or turned on or off either through configuring device 20, or by one or more additional buttons or other controls on device 20 that a user may manipulate. In still other embodiments, a loud sound may be emitted that is adapted to draw the attention of passersby and to scare away would be attackers. Such sound may include amplified calls for help, or other sounds that would likely draw the attention of passersby.

Device 20 includes a battery 56 that may be a rechargeable lithium ion or lithium ion polymer battery, or any other suitable type of battery. Battery 56 provides power to controller 38, GPS unit 74 (if present), and any other electrical components contained within device 20. If connector 70 is a USB port, or other port that receives electrical power, device 20 is configured to automatically re-charge battery 56 when connector 70 is coupled to an external source of power.

Device 20 further includes at least one antenna 58. Antenna 58 is configured to support GSM 850, 900, 1800, and/or 1900 communications. Antenna 58 may be configured, in some embodiments, to use wrist bands 30 and 32 as a ground plane. Antenna 58 may also be used for GPS communications, if device 20 is equipped with GPS capabilities. Still further, in some embodiments, antenna 58 is housed within a sheath that limits electromagnetic radiation exposure to the user so as to not exceed safe levels when communicating with the cellular telephone network. The sheath may be made of any suitable material, such as, but not limited to, a silicone composite.

As was described above, the embodiments of wearable alert device 20, 20a shown in FIGS. 1-10 are adapted to be worn on the wrist of a user. In the embodiment of FIGS. 1-5, wearable alert device 20 is adapted to be worn as a stand-alone device by wrapping bands 30 and 32 around the user's wrist. In the embodiment of FIGS. 6-10, device 20a is adapted to be attached to a wrist watch, bracelet, or other structure that the user is already wearing on his or her wrist. More specifically, in the embodiment of FIGS. 6-10, device 20a includes a pair of shortened bands 90 that are of a length that is generally insufficient to wrap around a user's wrist. Each shortened band 90 includes an aperture 92 at its end opposite housing 22. The apertures 92 are adapted to receive the bands of an existing wrist watch, bracelet, or other item that the user is already wearing. Those bands are inserted through a first one of apertures 92 and then inserted out of the second one of apertures 92.

When worn with a wrist watch, device 20a of FIGS. 6-10 is adapted to attach to the bands of the wrist watch such that housing 22 is positioned underneath the wrist watch. In other words, housing 22 will be positioned between the person's wrist and the wrist watch face. The face of the wrist watch will therefore generally cover the top face 24 of device 20a, while the bottom face 26 of device 20a will contact the wearer's skin. When worn in this fashion, device 20a will generally be concealed from view.

It will be understood that the embodiment of device 20a depicted in FIGS. 6-10 may include the same internal components as device 20 of FIGS. 1-5, and may operate in accordance with algorithm 60, or variations thereof, or in accordance with one or more different algorithms. Devices 20 and 20a of FIGS. 1-10 may also be modified to include different types of bands 30, 32, and 90 so that it may be attached in a different manner, or so that it may be attached to other locations on a user's body. As was noted, in one embodiment, device 20 may be coupled to a necklace worn by the user. In other embodiments, device 20 may be coupled to a user's belt, or belt loop, or still other objects.

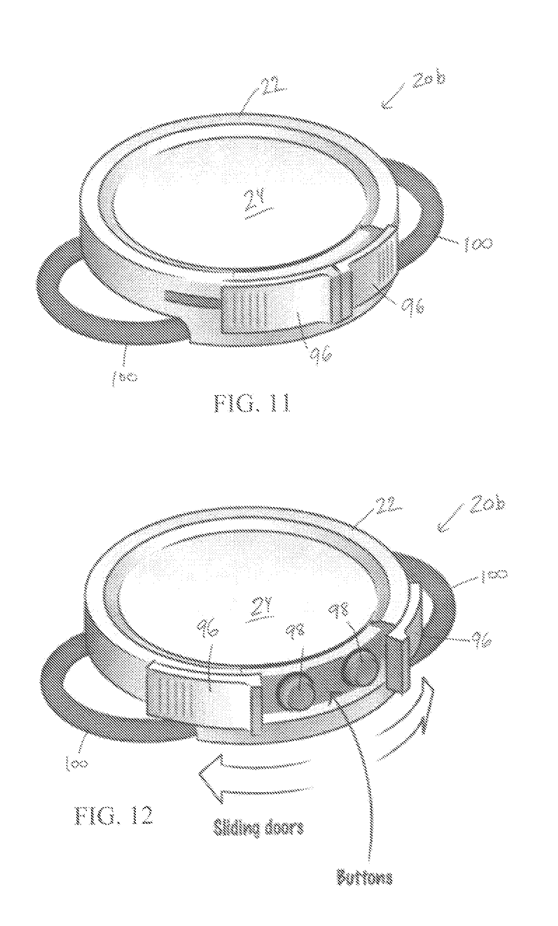

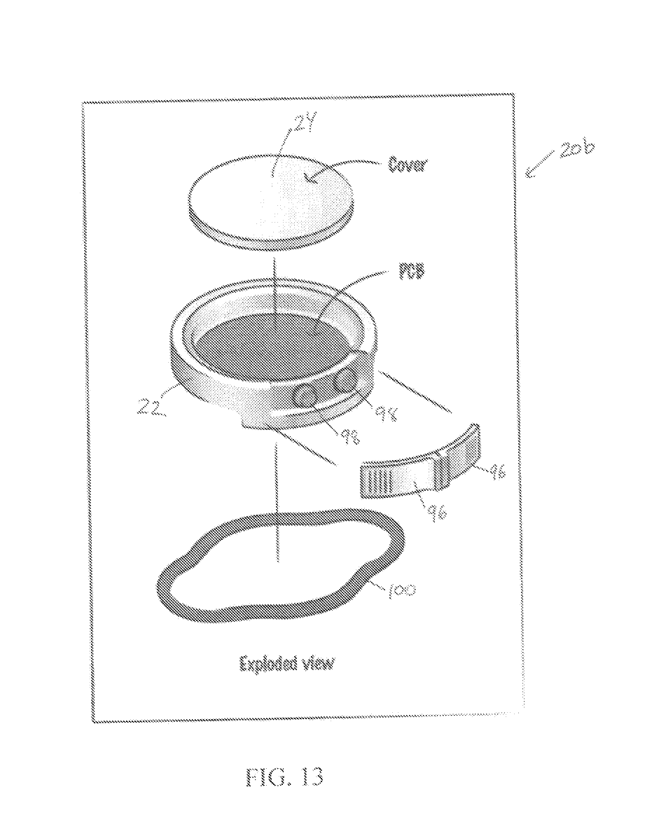

FIGS. 11-14 illustrate a third embodiment of device 20b. As with the embodiments of FIGS. 1-5 and 6-10, device 20b of FIGS. 11-14 may include the same internal components as device 20 of FIGS. 1-5, and may operate in accordance with algorithm 60, or variations thereof, or in accordance with one or more different algorithms. Device 20b of FIGS. 11-14 includes a housing 22 having a top face 24, a bottom face 26, and a perimeter wall 28. Integrated into a portion of perimeter wall 28 are a pair of sliding doors 96. Sliding doors 96 may be coupled to one or biasing members (not shown), such as springs, or the like, that urge sliding doors 96 toward the closed position illustrated in FIG. 11. When a user applies sufficient force to doors 96, the user urges them apart and into the position shown in FIG. 12. When the doors 96 are urged apart, a user has access to one or more buttons 98. Buttons 98 act in the same manner as tactile switches 44 described above, or they may control device 20b in other manners. In one embodiment, activation of device 20b in FIGS. 11-14 is achieved by pressing and holding buttons 98 for a predetermined threshold amount of time. Once activated, device 20b may then follow algorithm 60, or another algorithm.

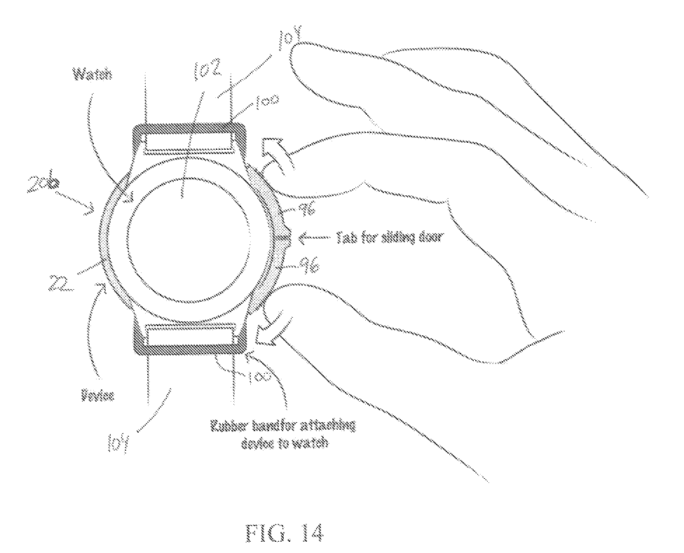

Device 20b of FIGS. 11-14 further includes a rubber band 100, or other type of fastening device, that enables device 20b to be attached to a conventional wrist watch 102. Each end of rubber band 100 may be wrapped around each of the two respective bands 104 of wrist watch 102 in the manner illustrated in FIG. 14. As shown therein, device 20b fits underneath the face of the wrist watch, thereby substantially concealing device 20b from view. It will be understood that device 20b of FIGS. 11-14 could be modified by replacing rubber band 100 with a pair of bands similar to first and second bands 30 and 32 so that it could be attached directly to a person's wrist as a stand-alone device. Still other modifications are possible.

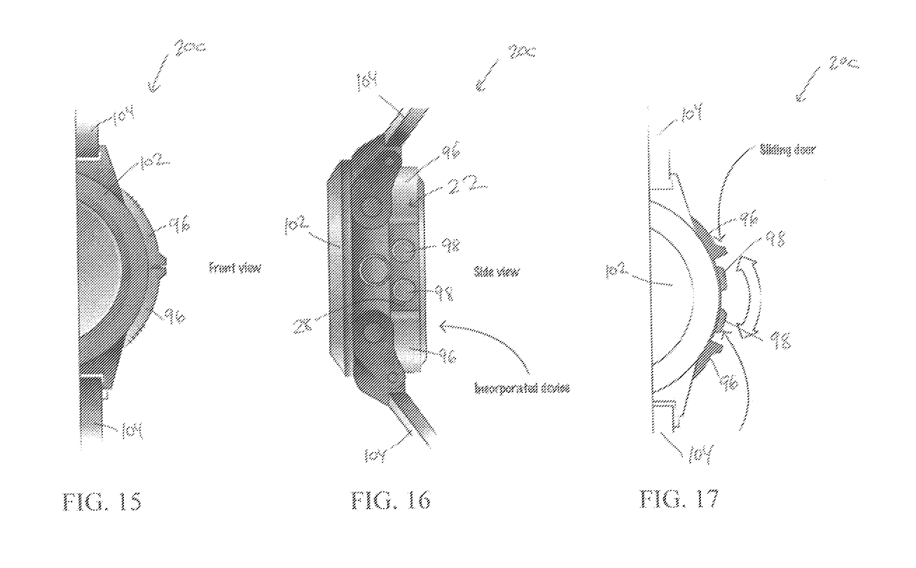

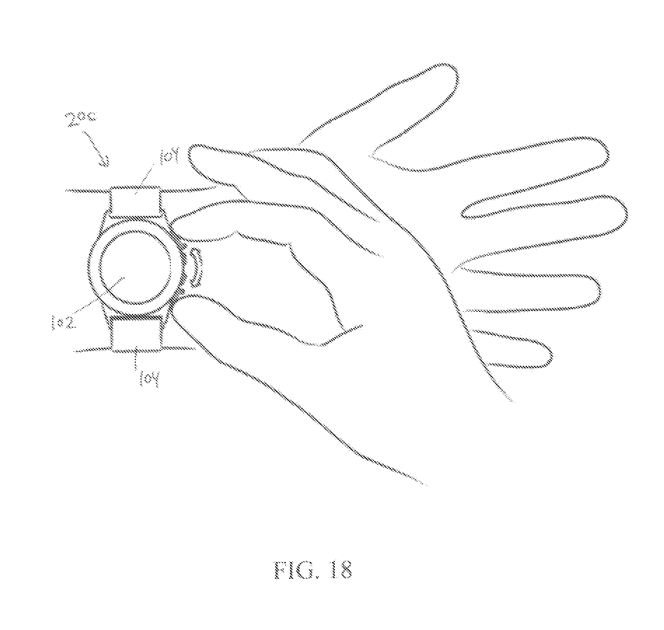

FIGS. 15-18 illustrate a fourth embodiment of a wearable emergency alert device 20c. In this embodiment, wearable emergency alert device 20c is integrated into a conventional wrist watch 102. Specifically, alert device 20c is attached to a back face of the wrist watch. The device 20c therefore does not need any separate bands to couple it to wrist watch 102. While the embodiment shown in FIGS. 15-18 shows device 20c as being a generally separate component of wrist watch 102, it will be understood by those skilled in the art that device 20c could be contained within a common housing that housed both the timekeeping components of wrist watch 102 as well as controller 38 and its associated components. Indeed, in some embodiments, device 20c could share one or more components with wrist watch 102, including, but not limited to, a battery, a microcontroller, or other control circuitry, and/or user interface structures (e.g. buttons, controls, etc.).

As shown in FIGS. 15-18, device 20c includes a pair of sliding doors 96 that provide selective access to a pair of buttons 98. It will be understood that buttons 98 could be replaced by tactile switches 44. In other words, the tactile switches 44 of FIGS. 1-10 could be incorporated into an embodiment of device 20c that was itself integrated into a conventional wrist watch 102. Still other types of controls besides buttons 98 and switches 44 could be used.

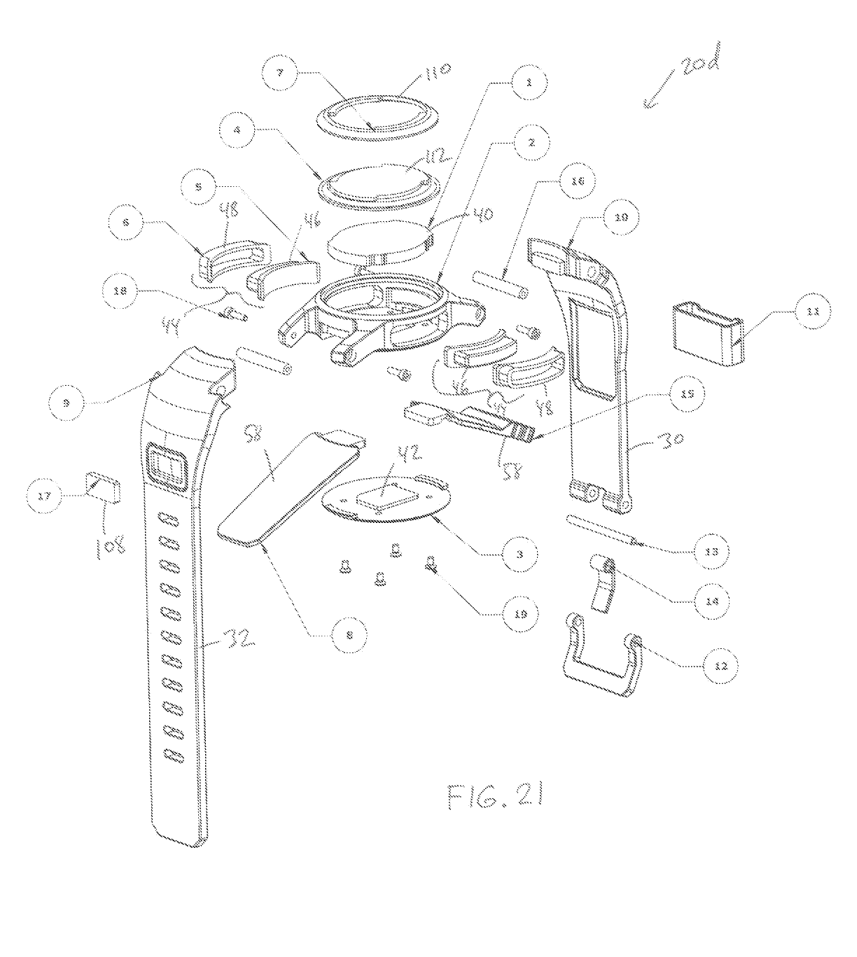

FIGS. 20-21 illustrate a fifth embodiment of an alert device 20d according to the present invention. Those components of alert device 20 of FIGS. 20-21 that are common to the alert device 20d of the previous embodiments bear the same reference numeral and operate in the same manner as previously described. Repeated description of these components is therefore unnecessary and omitted herein. Alert device 20d includes a bezel rim 110 mounted on top of a cover 112. Cover 112 and bezel rim 110 form the top face 24 of alert device 20d. Alert device 20d further includes a digital face 108 that is in electrical communication with control module 40. Digital face 108 is an electroluminescent display integrated into second band 32. Electroluminescent display 108 is controlled by control module 40 to display a background color and text that provides feedback to the user of alert device 20d. The colors used, the timing of their use, and the information displayed on display 108 may all vary, but in one embodiment, control device 20d is configured to display a green background color when alert device 20d has successfully established communication with an emergency services location after activation step 62. This green display provides visual confirmation to the user that, after pressing tactile switches 44, help has been successfully summoned. Text may be included with the green background color that confirms that help has been summoned.

Control module 40 also controls electroluminescent display 108 to display a red background color when, after activation step 62, device 20d is unable to complete its communication with the emergency services operator. Control module 40 also displays text on display 108 indicating further information about the inability to complete the phone call. Such text may further include instructions for the user to attempt to change location, or other instructions that might facilitate successful completion of the call. Control module 40 otherwise operates in accordance with the algorithms and functions previous described, such as notification algorithm 60.

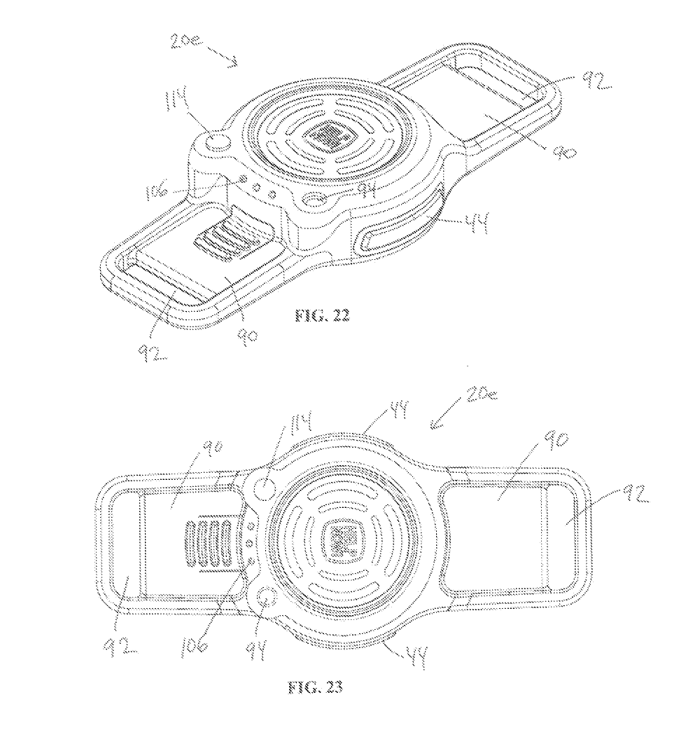

FIGS. 22 and 23 illustrate another embodiment of an alert device 20e that includes both a microphone 106 and a video camera 94. Device 20e further includes a button 114 for establishing voice communication with an emergency services responder. In some versions, a speaker (not shown) is included with device 20e so that the user is able to hear the voices of the emergency services responder. Alternatively, in other versions, no such speaker is included, and the user of device 20e is only able to transmit aural signals to the emergency services responder, but not hear any aural sounds back from the emergency services provider. Device 20e operates by detecting ambient aural sounds after button 114 is pressed. Such ambient aural sounds are detected by microphone 106, converted to electrical signals, and then forwarded to the emergency services operator in the same way that voice signals are detected and forwarded using conventional cell phone technology. When a user releases button 114, the forwarding of such ambient sounds to the emergency services responder ceases.

Video camera 94 is a conventional video camera of the type commonly found integrated into cell phones. Video camera 94 is adapted to start recording video after device 20e is activated. Such video is relayed to the emergency services responder (if they are equipped to receive it), and/or to the secondary emergency contact. In some instances, instead of forwarding the entire video, selected snapshots (such as once every second, or some other interval) are forwarded, thereby reducing bandwidth and computational resources. In some embodiments, video camera 94 is a wide angle lens so that images are captured of virtually the entire surrounds of the user of device 20e.

In various other embodiments, when any of the alert devices 20, 20a, 20b, 20c, 20d and/or 20e are integrated into a wrist watch—such as wrist watch 102—the alert device includes a battery separate from the battery used to power the watch functions. The use of two batteries extends the life of functionality of alert device. More specifically, when two batteries are included, they are electrically connected to the alert device such that power for the alert device is always first drawn from the watch battery, and then, only after the watch battery has been drained, will the alert device draw power from its own battery. Further, the watch batter is connected to the watch circuitry such that, when the watch battery is drained, the watch functions will cease to operate. This will be a cue for the user to replace the watch battery. The alert device, however, will continue to operate on its own battery until the watch battery is replaced, at which time it will switch back to drawing power from the watch battery. The battery for the alert device will therefore always ensure that the alert device is sufficiently powered, provided a user does not fail to replace the watch battery for a time longer than the life of the alert device battery.

Still further, in those embodiments where alert device 20, 20a, 20b, 20c, 20d, and/or 20e are integrated into wrist watch 102 and there are two separate batteries, the battery used exclusively by the alert device may be a rechargeable battery that is able to be recharged via the watch battery. Therefore, in those situations where the first watch battery is drained and alert the device switches to drawing power from its own battery, this cumulative drain on the alert device will be recharged at the time the user replaces the watch battery (or recharges the watch battery, if it too is rechargeable).

For any of the various embodiments described herein (20, 20a, 20b, 20c, 20d, and 20e), the battery used to power the alert device is used only when a person activates the notification algorithm (e.g. pushes on tactile switches 44), tests the alert device, configures the alert device, or otherwise interacts with it. In other words, the battery is not being actively drained while a person is wearing the alert device and no alerting is taking place. Unlike conventional cell phones, that still make electrical contact with cell phone towers between phone calls (while the cell phone is turned on), the alert device does not communicate with the cell phone towers when it has not been activated. This is true regardless of whether or not there are two batteries—one for the watch functions and one for the alert functions—or only a single battery. By using the battery only after the activation has occurred, the battery life is extended.

In addition to the features described in the various embodiments discussed above, any of embodiments of device 20 (e.g. 20, 20a, 20b, 20c, and/or 20d) may be further modified to include one or more of the features discussed below. Any of the alert devices 20, 20a, 20b, 20c, and/or 20d can be configured to include a microphone, video camera, or other sound-detecting device (like alert device 20e), that, upon activation, detects sounds within the vicinity of the alert device and forwards the sound to either or both of the emergency services operator and the secondary emergency contact. Such forwarding of the sounds can be done directly, or it can be done via a voice-to-text converter, or both. In other words, any aural sounds that are recognizable by the voice-to-text converter will be converted to text and forwarded as text to either or both of the emergency services operator and the secondary emergency contact. Such text is forwarded every set number of seconds, or after a threshold amount of text is generated, or after a combination of these two. This sound communication feature allows the emergency services operator and/or the text message recipient to listen to what the user is saying, or to otherwise hear what is happening in the vicinity of the user of the alert device. In still other embodiments, the alert device includes a speaker that allows two-way communication with the emergency services operator.

One or more miniature cameras can also be included within any of the alert devices 20, 20a, 20b, 20c, and/or 20d that are configured to automatically turn on after the alert device has been activated (similar to alert device 20e). When the alert device is connected to an e911 system that accepts video feeds, the information detected by the one or more cameras is forwarded to the e911 operator to provide visual information about the circumstances of the emergency. In those situations where the 911 services are not able to accept video, the alert device stores the video images in memory for later retrieval (e.g. via connector or port 70).

In some situations, the e911 service may allow for testing the alert device (20, 20a, 20b, 20c, 20d, and/or 20e) to confirm its operability. In such instances, the alert device includes a mode that allows a test message to be sent to the e911 services to confirm its proper operation. This testing mode may be accessed and/or implemented in different manners. In one manner, the user activates this testing mode by pressing on only a single one of the tactile switches 44, or buttons 98. This activates the testing mode, which is confirmed visually or aurally (e.g. a green light, or other indicator contained with the alert device, such as electroluminescent display 108). The test mode also allows the user to contact his or her secondary emergency contact to confirm receipt of the secondary text message sent at step 76 of algorithm 60.

In any of the embodiments described above (20, 20a, 20b, 20c, 20d, and/or 20e) where sound and/or video is recorded by the alert device after activation, the alert device can be modified via suitable programming to forward such sound and/or video information to the secondary contact, either in addition to, or in lieu of, the emergency services operator. Thus, for example, when the alert device includes a microphone, in addition to forwarding these sounds to the emergency services operator, the alert device can be suitably programmed to additionally convert these sounds to text and to send them via SMS to the designated secondary contact, all at the same time as the forwarding of the voice signals to the emergency services operator. Further, where video recording capabilities are included within the alert device, the alert device can be configured to forward video signals to both the emergency services operator and the secondary contact. If the emergency services operator does not have the IT infrastructure available to accept the video, the secondary contact will still be able to see the video and take appropriate action.

In those embodiments where the alert device (20, 20a, 20b, 20c, 20d, and/or 20e) is integrated together with a conventional wrist watch, (i.e. the alert device includes time-keeping features and some sort of mechanical or electrical display on top face 24 for displaying the time), the alert device may include one or more features that are found on conventional sport watches. Such features could include one or more sensors for taking the user's heartbeat and determining their heart rate, as well as measuring the amount of calories a user has burned (such as by measuring speed and distance traveled). This information could then be selectively displayed on a screen on top face 24. Automatic alerts could be programmed into the alert device that alerted the user when his or her heart rate exceeded a desired maximum, or otherwise left a desired target range of heart rates.

When configured as a combined emergency alert device and a sports watch, the alert device could also include a race mode that prevents the device from going into a power saving mode while turned on. It could further include an automatic sync feature that wirelessly transfers data to similar alert devices, or to a user's computer or other electronic device. A mode could also be included that allows a user to train against an imaginary digital person. Data could be stored in the alert device regarding past workouts so that the user could compete against his or her prior achievements. The display included on the alert device could automatically cycle through different information during the workout. Custom workouts could also be created and stored in the alert device. A pace alerting feature could be included that triggers an alarm if the user varies from a specified pace. Time and distance alerts could also be included that indicated when the user has reached specific goals of their workout. Multiple customizable displays could be included on the alert device.

Detailed summaries of past runs may be displayable on the display. An interval training option could be included that lets the user see his or her pace for customizable exercise and rest intervals. The device could be water resistant for enabling it to be safely worn during swimming exercise (such as up to 1 meter of depth of more). The device could be made compatible with other exercise equipment so as to be able to communicate therewith and/or share information. A lap counting feature could be included that automatically starts a new lap, counts laps, and/or displays an average pace of the last lap. If the lap feature is off, the alert device may display an average pace of the entire activity. Lap histories may also be stored in memory.

A power down feature could be included that allows the user to prolong battery life. Dual time could be displayed on the alert device, and the alert device may include one or more alarms that are programmable for time-based alarms (e.g. morning alarms). A standard snooze feature could also be included with the time-base alarms.

Any of the alert devices (20, 20a, 20b, 20c, 20d and/or 20e) may also include a GPS unit 74, as noted above, that determines the location of device 20 using GPS. When so equipped, the GPS feature may also be used to determine a person's distance traveled, time, pace, and other information that would be useful during an exercise workout. The GPS feature could also be used to display a compass on the alert device. Favorite locations could also be stored in the alert device.

In still other embodiments, whether the alert device includes timekeeping features or not, it may be modified to emit an emergency beacon upon activation if no cellular telephone service is detected. In such embodiments, controller 38 would first attempt to contact a 911 or e911 communications center. If this was not possible because the user was outside of cellular communication range, or for other reasons, controller 38 would then emit a distress radio beacon signal that would be detected by one or more satellite systems. As but one example, device 20 could emit an emergency beacon that communicated with the Cospas-Sarsat alert detection and information distribution system. In such cases, the alert device would act as a personal locator beacon (PLB). Communication with other satellite systems would also be possible. Still further, the alert device could be configured to communicate its GPS location, if available, to whatever satellite system it was configured to communicate with. In this embodiment, a user of the alert device would be able to communicate emergency notification regardless of whether or not they were in range of a cellular telephony network.

It will also be understood by those skilled in the art that, in any of the various embodiments discussed herein, the alert device could be further modified to forward information to more than one secondary contact. Thus, instead of sending only a single text message with the user's current location to a single secondary contact, multiple text messages with the location information could be sent to multiple secondary contacts. Further, the forwarding of this information could be done serially and in a manner based upon whether or not a response is received from the first set of secondary contacts or not. If no response is received at the alert device within a threshold (configurable by the user), then the alert device will forward the SMS message to a second set of secondary contacts. Such escalation of alerts to additional secondary contacts ensures that at least one secondary contact person will be alerted. Such escalation occurs in the background to the phone call established with the emergency services operator.

It will further be understood by those skilled in the art that references to the term “e911” are not meant to be limiting to a particular emergency services system, but instead are intended to broadly include any public emergency services system in which the first responders are equipped with the appropriate information technology to receive, at a minimum, text messages from emergency callers. The term “e911” therefore includes systems that the Federal Communications Commission (FCC) is currently referring to as next generation 911 (or NG911), as well as any other systems encompassing the ability to receive digital data in addition to voice signals. In addition to systems having the ability to receive text messages, the term “e911” includes those having additional features, such as the ability to receive videos and/or any other digital data.

The above descriptions are that of several embodiments of the invention, but which are not exhaustive of all possible embodiments. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A wearable emergency alert device comprising:
a housing;
a user control coupled to said housing and adapted to activate said device; and
a controller contained within said housing having a cellular transceiver, said controller configured to automatically communicate a current location of the wearable alert device to an emergency services operator using said cellular transceiver and to transmit a text message to a predetermined recipient upon a user activating said user control, said predetermined recipient being different from said emergency services operator.

2. The device of claim 1 wherein said wearable alert device does not include any controls for enabling a user to dial an arbitrary phone number.

3. The device of claim 1 wherein said controller automatically communicates with the emergency services operator by at least one of dialing 911, or sending a text message to an e911 emergency services operator.

4. The device of claim 3 wherein said controller transmits a predetermined aural message if said automatic communication is made by dialing 911.

5. The device of either claim 3 wherein said device is user configurable to allow a user to select between dialing 911 or sending a text message to an e911 emergency services operator.

6. The device of claim 1 wherein said controller periodically re-determines the location of the wearable device after automatically communicating with the emergency services operator and forwards any new location information to the emergency services operator.

7. The device of claim 6 wherein said controller determines a location of the wearable device based upon communications with at least one cell phone tower.

8. The device of claim 6 wherein said device determines a location of the wearable device based upon satellite global positioning system (GPS) signals.

9. The device of claim 1 wherein wearable alert device is adapted to be worn on a person's wrist.

10. The device of claim 9 wherein said wearable alert device includes a wrist band coupled to the housing that may be wrapped around a user's wrist.

11. The device of claim 1 wherein said wearable alert device includes a fastener coupled to the housing that is adapted to attach to the wrist band of a watch worn by a user.

12. The device of claim 11 wherein said housing is disk shaped and said controller is positioned inside of the disk shaped housing, said disk shaped housing being sized and positioned to lie underneath a wrist watch worn by said user.

13. The device of claim 1 wherein said wearable alert device includes a watch integrated therein for displaying time to a user of said wearable device.

14. The device of claim 1 wherein said user control includes a plurality of switches that must be simultaneously activated for a predetermined time period in order to cause said controller to initiate communications with the emergency services operator.

15. The device of claim 14 wherein said user control is adapted to be activatable only if both sufficient heat and force is applied to it.

16. The device of claim 1 wherein said wearable device is user configurable to allow a user to select the predetermined recipient of said text message.

17. The device of claim 1 wherein said wearable device is user configurable to allow a user to select the content of said text message.

18. The device of claim 1 wherein said controller does not allow said wearable device to terminate an emergency phone call made to 911 until said emergency services operator terminates the phone call.

19. The device of claim 1 further including a micro-universal serial bus (USB) port adapted to allow a user to configure said wearable device and to re-charge a battery contained within said housing.

20. The device of claim 1 further including a satellite transceiver adapted to communicate with an emergency services operator via satellite, said controller adapted to transmit the current location of the wearable device via the satellite transceiver if said controller is unable to successfully communicate with the emergency services operator via said cellular transceiver.

21. The device of claim 1 further including automatically transmitting a second text message to a second predetermined recipient upon a user activating said user control, said second predetermined recipient being different from said predetermined recipient.

22. The device of claim 1 wherein said wearable device further includes an aural indicator adapted to emit an aural sound when said user control is activated.
